(19) United States
(12) Patent Application Publication
(10) Pub. No.: US 2006/0102476 A1
(43) Pub. Date: May 18, 2006

(54) Sensor impedance measuring apparatus for improving measurement accuracy of gas sensor

(75) Inventors: Mitsunobu Niwa, Kariya-shi (JP); Satoshi Hada, Inazawa-shi (JP); Eiichi Kurokawa, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/273,325

(22) Filed: Nov. 15, 2005

(30) Foreign Application Priority Data
Nov. 15, 2004 (JP) 2004-331017
May 9, 2005 (JP) 2005-136456
Oct. 6, 2005 (JP) 2005-293202

(51) Int. Cl. G01N 27/26

(52) U.S. Cl. 204/425; 204/421

(57) ABSTRACT

A sensor impedance measuring apparatus is provided which is designed to apply one of an alternating voltage swept in level to a positive and a negative side to a sensor element of a gas sensor such as an O₂ sensor or an A/F sensor and sample the voltage developed at an end of the sensor element to determine the impedance of the sensor element. The determined impedance is, for example, used to control energization of a heater built in or affixed to the sensor element to control the activation of the sensor element for ensuring the accuracy in measuring the concentration of a gas.

### CROSS REFERENCE TO RELATED DOCUMENT

The present application claims the benefit of Japanese Patent Application No. 2004-331017 filed on Nov. 15, 2004, Japanese Patent Application No. 2005-136456 filed on May 9, 2005, and Japanese Patent Application No. 2005-293202 filed on Oct. 6, 2005, the disclosures of which are incorporated herein by reference.

### BACKGROUND OF THE INVENTION

1. Technical Field of the Invention

The present invention relates generally to a sensor impedance measuring apparatus designed to measure the impedance of a gas sensor for improving the measurement accuracy of the gas sensor and a gas concentration measuring apparatus equipped with such a sensor impedance measuring apparatus.

2. Background Art

There are known a variety of techniques of measuring the concentration of oxygen contained in exhaust emissions of automotive internal combustion engines to use it for controlling the quantity of fuel to be injected into the engine. Such techniques usually use oxygen sensors (generally called O₂ sensors) or limiting current air-fuel ratio sensors (generally called A/F sensors). The O₂ sensors are equipped with a sensor element which is made up of a solid electrolyte layer and a pair of electrodes affixed to opposed surfaces of the solid electrolyte layer and work to produce an electromotive force at either of two voltage levels depending upon whether the exhaust gasses of the engine is in rich or lean state. The A/F sensors have a sensor element which is provided with a diffusion rate-determining layer and responsive to application of voltage thereto to produce an electric current (i.e., a limiting current) for use in determining the air-fuel ratio of a mixture supplied to the engine.

Ensuring the accuracy of measuring the concentration of oxygen in the O₂ or A/F sensors requires keeping the sensor element activated at given temperatures. This is usually achieved by controlling the energization of a heater built in or affixed to the sensor element. It is generally known that the O₂ sensors are easier in controlling the temperature thereof than the A/F sensors. The controlling of the temperature of the O₂ sensors is usually accomplished by adjusting an electric power to be supplied to the heater to a selected one. The A/F sensors are generally required to be controlled in the temperature thereof with higher accuracy because of a need for applying the voltage to the sensor element within a limiting current range at all times. The controlling of the temperature of the A/F sensors is typically accomplished by using the impedance of the sensor element. The impedance may be found, for example as taught in Japanese Patent First Publication No. 2004-177178, by sweeping the voltage applied to the sensor element in an ac form, sampling a resulting change in current through the sensor element, and determining the impedance based on the swept voltage and the sampled resulting changed.

When the sweeping of the voltage is made by shifting the level thereof to only one of positive and negative sides, it may result in distortion of polarization in the sensor element, thus leading to decreased accuracy of an output of the sensor. Because of this, the sweeping of the voltage is preferably accomplished by shifting the level thereof both to the positive and negative sides.

In recent years, emission control regulations have been tightened. The improvement on the stability of output of the O₂ sensors is, therefore, sought. The achievement of this requires controlling the activation of the sensor element more accurately, thus resulting in the need for measurement of the impedance of the O₂ sensors to control the temperature thereof.

The measurement of the impedance of the O₂ sensors, however, encounters the following problem.

The O₂ sensors may output an electromotive force of approximately 0V. In such an event, it becomes impossible to sweep the voltage applied to the sensor element either to the positive or negative side. For instance, if allowed to be swept to the positive side, the voltage is difficult to sweep to the negative side, thus resulting in the distortion of polarization of the sensor element which leads to a decrease in accuracy of output of the sensors.

### SUMMARY OF THE INVENTION

It is therefore a principal object of the invention to avoid the disadvantages of the prior art.

It is another object of the invention to provide a sensor impedance measuring apparatus designed to measure the impedance of a gas sensor with high accuracy without sacrificing the stability of output of the sensor and a gas concentration measuring apparatus equipped with such a sensor impedance measuring apparatus.

According to one aspect of the invention, there is provided a sensor impedance measuring apparatus which is used to measure the impedance of a gas sensor equipped with a sensor element including a solid electrolyte body and a pair of electrodes affixed to opposed surfaces of the solid electrolyte body. The sensor element works to produce an electromotive force between the electrodes as a function of concentration of oxygen contained in a gas. The sensor impedance measuring apparatus comprises: (a) a circuit line extending through the gas sensor equipped; (b) an ac applying circuit disposed in a current path that is a portion of the circuit line and leads to one of the electrodes of the sensor element, the ac applying circuit working to applying one of an alternating voltage and an alternating current swept in level to a positive and a negative side to the sensor element; (c) a storage device installed in the ac applying circuit, the storage device working to block a flow of direct current and store charges therein; (d) a voltage sampling circuit working to sample a voltage developed between the sensor element and the ac applying circuit; and (e) an impedance determining circuit working to determine an impedance of the sensor element as a function of a value of the voltage sampled by the voltage sampling circuit while the one of the alternating voltage and the alternating current is being applied by the ac applying circuit to the sensor element.

The gas sensor, as already described in the introductory part of this application, may output an electromotive force of approximately 0V. In such an event, it becomes impossible to sweep the voltage applied to the sensor element either to the positive or negative side on the current path leading to the sensor element. The storage device serves to alleviate such a problem in the nature of its acvitity, thus eliminating the distortion of polarization in the sensor element in an impedance measuring mode to ensure the accuracy of output of the gas sensor.

The gas sensor is designed to use the same cell in measuring the concentration of gas and the impedance of the sensor element. The measurement of the impedance of the sensor element is performed during the measurement of the concentration of gas. There is, therefore, a greater concern about adverse effects of the alternating change in voltage or current used in measuring the impedance on the measurement of the concentration of gas. The capacitor device, however, works to allow the alternating voltage or current to pass therethrough, but block a dc current, thus minimizing the above adverse effects on the measurement of the concentration of gas.

The measurement of the impedance of the sensor element is achieved by sampling the voltage appearing at an end of the sensor element following the change in voltage. This causes the sampled voltage to have, unlike the impedance measuring system, as taught in, for example, Japanese Patent First Publication No. 63-140955, a correlation to the impedance of the sensor element during the convergence thereof, thereby ensuring the accuracy in determining the impedance of the sensor element.

During the application of the alternating voltage or current to the sensor element, the peak of voltage developed across the sensor element has a correlation to the impedance of the sensor element. In the case where a low-pass filter is used to eliminate electrical noises arising from on/off operations of a heater built in the gas sensor or any other noises, the peak of voltage will be smoothed in level by the low-pass filter. Impedance measuring systems, as taught in, for example, Japanese Patent First Publication No. 63-140955, designed to sample the voltage appearing across the sensor element are, therefore, lower in accuracy in determining the impedance of the sensor element. The impedance measuring apparatus of the invention uses the voltage, as sampled from one of terminals of the sensor element, to determine the impedance of the sensor element, thus enabling the low-pass filter to be used without sacrificing the accuracy in determining the impedance of the sensor element.

In the preferred mode of the invention, the storage device is made up of a resistor device and a capacitor device which are connected in series. The capacitor device may be implemented by a coupling capacitor.

The impedance determining circuit works to determine the impedance of the sensor element based on a fraction of the voltage applied by the ac applying circuit to the sensor element which is given by a ratio of the sum of resistance values of the resistor device and the capacitor device to a total of the resistance value and the impedance of the sensor element.

The capacitor device is smaller in capacity than the sensor element. This eliminates adverse effects of individual variability or aging of the sensor element on the voltage, as sampled by the voltage sampling circuit.

The capacitor device has preferably a static capacity of 0.1 to 1 μF.

The impedance determining circuit may include a peak hold circuit and receives the voltage, as sampled by the voltage sampling circuit, through the peak hold circuit.

The impedance determining circuit may determine the impedance of the sensor element based on the voltage, as sampled by the voltage sampling circuit, and the sum of resistance values of the resistor device and the capacitor device.

The impedance determining circuit may alternatively determine the impedance of the sensor element based on the voltage, as sampled by the voltage sampling circuit, and a resistance value of the resistor device.

The ac applying circuit may include a power supply and two transistors joined in series between the power supply and ground. The ac applying circuit works to turn on the transistors alternately to produce the one of the alternating voltage and the alternating current. The impedance determining circuit determines the impedance of the sensor element also using an on-resistance of one of the transistors.

The voltage sampling circuit samples a value of the voltage developed between the sensor element and the ac applying circuit when, after sweeping the one of the alternating voltage and the alternating current to one of a positive and a negative side, the ac applying circuit sweeps the one to the other of the positive and negative sides. The impedance determining circuit determines the impedance of the sensor element as a function of the value, as sampled by the voltage sampling circuit.

The ac applying circuit may produce the one of the alternating voltage and the alternating current at a frequency selected to be insensitive to a resistance of the current path.

The ac applying circuit may also produce the one of the alternating voltage and the alternating current at a frequency selected to be greater than a change in concentration of the oxygen in the gas.

According to the second aspect of the invention, there is provided a sensor impedance measuring apparatus which comprises: (a) a circuit line extending through a gas sensor equipped with a sensor element which includes a solid electrolyte body and a pair of electrodes affixed to opposed surfaces of the solid electrolyte body, the sensor element working to produce an electromotive force as a function of concentration of oxygen contained in a gas; (b) an ac applying circuit disposed in a current path that is a portion of the circuit line and leads to one of the electrodes of the sensor element, the ac applying circuit working to applying one of an alternating voltage and an alternating current to the sensor element; (c) a voltage sampling circuit working to sample a voltage developed between the sensor element and the ac applying circuit; and (d) an impedance determining circuit working to determine an impedance of the sensor element as a function of a value of the voltage sampled by the voltage sampling circuit while the one of the alternating voltage and the alternating current is being applied by the ac applying circuit to the sensor element.

In the preferred mode of the invention, the sensor impedance measuring apparatus further comprises a storage device installed in the ac applying circuit. The storage device works to block a flow of direct current and store charges therein and includes a resistor device and a capacitor device which are connected in series. The impedance determining circuit determines the impedance of the sensor element based on the voltage, as sampled by the voltage sampling circuit, and a resistance value of the resistor device.

The ac applying circuit may include a power supply and two transistors joined in series between the power supply and ground. The ac applying circuit works to turn on the transistors alternately to produce the one of the alternating voltage and the alternating current. The impedance determining circuit determines the impedance of the sensor element also using an on-resistance of one of the transistors.

The voltage sampling circuit samples a value of the voltage developed between the sensor element and the ac applying circuit when, after sweeping the one of the alternating voltage and the alternating current to one of a positive and a negative side, the ac applying circuit sweeps the one to the other of the positive and negative sides. The impedance determining circuit determines the impedance of the sensor element as a function of the value, as sampled by the voltage sampling circuit.

The ac applying circuit may produce the one of the alternating voltage and the alternating current at a frequency selected to be insensitive to a resistance of the current path.

The ac applying circuit may alternatively produce the one of the alternating voltage and the alternating current at a frequency selected to be greater than a change in concentration of the oxygen in the gas.

According to the third aspect of the invention, there is provided a gas concentration measuring apparatus comprising: (a) a circuit line extending through a gas sensor equipped with a sensor element which includes a solid electrolyte body and a pair of electrodes affixed to opposed surfaces of the solid electrolyte body; (b) an ac applying circuit disposed in a current path that is a portion of the circuit line and leads to one of the electrodes of the sensor element, the ac applying circuit working to applying one of an alternating voltage and an alternating current to the sensor element; (c) a voltage sampling circuit working to sample a voltage developed between the sensor element and the ac applying circuit; (d) an impedance determining circuit working to determine an impedance of the sensor element as a function of a value of the voltage sampled by the voltage sampling circuit while the one of the alternating voltage and the alternating current is being applied by the ac applying circuit to the sensor element; (e) a voltage applying circuit disposed in the circuit line, the voltage applying circuit working to apply a voltage to the sensor element; (f) a current measuring circuit disposed in the circuit line, the current sampling circuit working to measure a current flowing therethruogh which arises from application of the voltage to the sensor element by the voltage applying circuit; and (g) a controller working to determine a concentration of oxygen in a gas using the current, as measured by the current measuring circuit. The controller works to block the application of the voltage to the sensor element when the ac applying circuit is required to apply the one of the alternating voltage and the alternating current to the sensor element. The controller also works to control the gas sensor using the impedance, as determined by the impedance determining circuit.

In the preferred mode of the invention, the apparatus further comprises a switch disposed between the voltage applying circuit and the sensor element. The controller opens the switch to block the application of the voltage to the sensor element.

The gas concentration measuring apparatus may further comprise a storage device installed in the ac applying circuit. The storage device works to block a flow of direct current and store charges therein and includes a resistor device and a capacitor device which are connected in series. The impedance determining circuit determines the impedance of the sensor element based on the voltage, as sampled by the voltage sampling circuit, and a resistance value of the resistor device.

The ac applying circuit may include a power supply and two transistors joined in series between the power supply and ground. The ac applying circuit works to turn on the transistors alternately to produce the one of the alternating voltage and the alternating current. The impedance determining circuit determines the impedance of the sensor element also using an on-resistance of one of the transistors.

The voltage sampling circuit samples a value of the voltage developed between the sensor element and the ac applying circuit when, after sweeping the one of the alternating voltage and the alternating current to one of a positive and a negative side, the ac applying circuit sweeps the one to the other of the positive and negative sides. The impedance determining circuit determines the impedance of the sensor element as a function of the value, as sampled by the voltage sampling circuit.

The ac applying circuit may produce the one of the alternating voltage and the alternating current at a frequency selected to be insensitive to a resistance of the current path.

The ac applying circuit may alternatively produce the one of the alternating voltage and the alternating current at a frequency selected to be greater than a change in concentration of the oxygen in the gas.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram which shows a gas concentration measuring apparatus according to the invention;

FIG. 2 is a partially vertical sectional view which shows a sensor element of a gas sensor to be controlled by the gas concentration measuring apparatus of FIG. 1;

FIG. 3 is a graph which demonstrates a relation between an electromotive force, as produced by the sensor element of FIG. 2, and an excess air ratio;

FIG. 4 is a circuit diagram which shows a circuit structure of an ac voltage source installed in the gas concentration measuring apparatus of FIG. 1;

FIG. 5(a) is a circuit diagram which illustrates an example of a circuit structure of a conventional impedance measurement system;

FIG. 5(b) is a view which shows a change in voltage produced by sweeping the voltage applied to an A/F sensor in FIG. 5(a);

FIG. 5(c) is a view which shows the change in voltage, as demonstrated in FIG. 5(b), to which a heater noise is added and an output of a peak hold circuit;

FIG. 6(a) is a partial diagram which shows an impedance measuring system of the gas concentration measuring apparatus of FIG. 1;

FIG. 6(b) is a view which shows a change in voltage produced by sweeping the voltage applied to a gas sensor in FIG. 6(a);

FIG. 6(c) is a view which shows the change in voltage, as demonstrated in FIG. 6(b), to which a heater noise is added and an output of a peak hold circuit;

FIG. 7(a1) is a view which shows changes in voltage appearing at an end of a gas sensor for difference values of the impedance of the gas sensor;

FIG. 7(a2) is a view which shows a relation of an output of a peak hold circuit to the changes in voltage of FIG. 7(a1);

FIG. 7(b1) is a view which shows changes in voltage appearing across a divider resistor for different values of the impedance of a gas sensor;

FIG. 7(b2) is a view which shows a relation of an output of a peak hold circuit to the changes in voltage of FIG. 7(b1) when a low-pass filter in the peak hold circuit has a smaller constant;

FIG. 7(b3) is a view which shows a relation of an output of a peak hold circuit to the changes in voltage of FIG. 7(b1) when a low-pass filter in the peak hold circuit has a greater constant;

FIG. 8 is a flowchart of a program to determine the impedance of a gas sensor;

FIG. 9 is a time chart which shows waveforms of on/off signals SG1 and SG2 outputted to transistors of an ac voltage source of the gas concentration measuring apparatus of FIG. 1 and voltages Va, Vb, Vc, Vd, and Ve appearing in an impedance measuring mode;

FIG. 10 is a circuit diagram which shows a modification of an ac applying circuit which may be used in the gas concentration measuring apparatus of FIG. 1;

FIG. 11 is a block diagram which shows a sensor driver for an A/F sensor according to the second embodiment of the invention; and

FIG. 12 is a block diagram which shows a modification of the sensor drive of FIG. 11.

### DESCRIPTION OF THE PREFERRED EMBODIMENTS

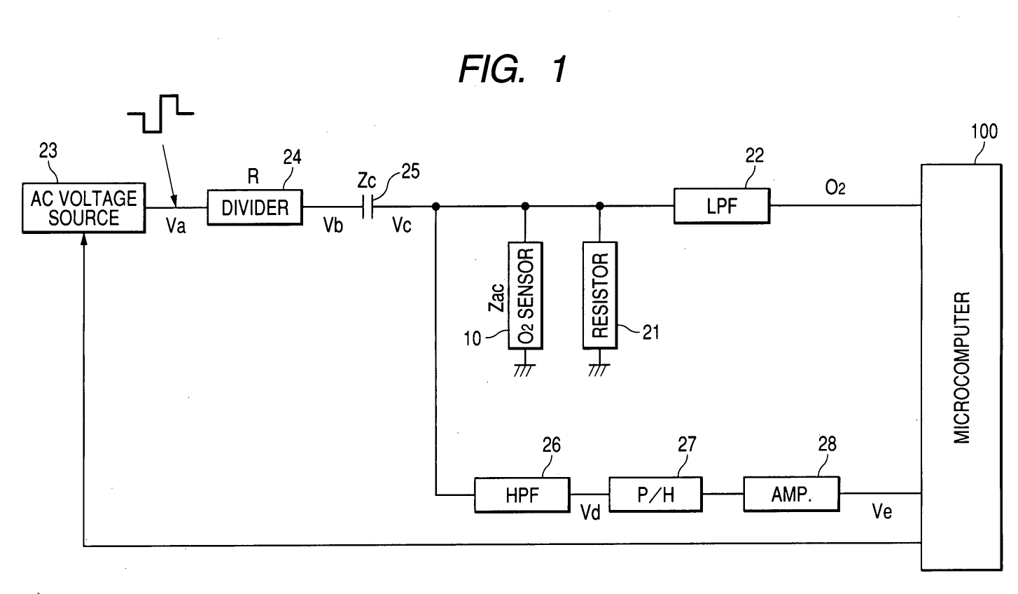

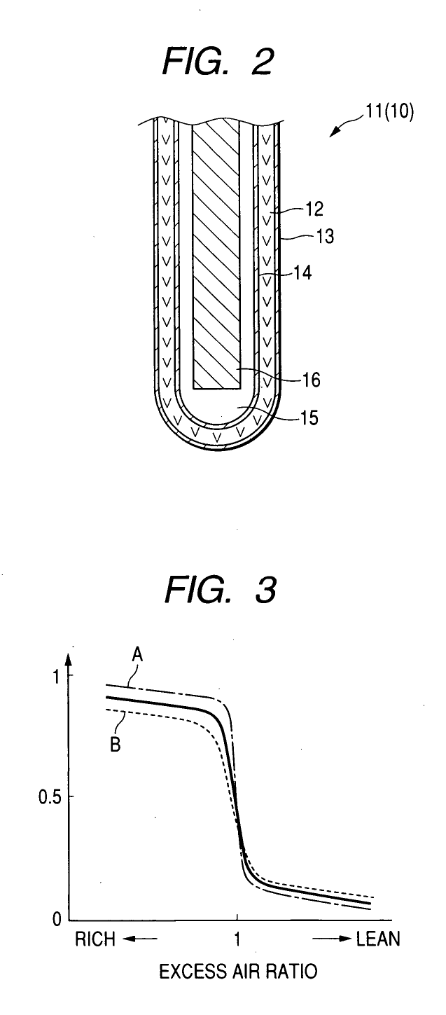

Referring now to the drawings, particularly to FIG. 1, there is shown a gas concentration measuring apparatus according to the invention which is designed to sample exhaust gasses emitted from an internal combustion engine mounted in an automobile to measure the concentration of oxygen (O₂) contained in the exhaust gasses for determining an air-fuel (A/F) ratio of a mixture supplied to the engine. The determined A/F is typically used in an air-fuel ratio control system made of an engine ECU, etc. to perform stoichiometric burning control to bring the A/F ratio near the stoichiometric air-fuel ratio under feedback control. The gas concentration measuring apparatus includes an oxygen (O₂) sensor 10 which has an internal structure in cross section, as illustrated in FIG. 2. The oxygen sensor 10 includes a cup-shaped sensor element 11 which is typically retained in a cylindrical housing (not shown) and covered with a protective cover assembly (not shown). In use, the oxygen sensor 10 is installed in an exhaust pipe of the engine and exposed to the exhaust gasses.

The sensor element 11 is made up of a cup-shaped solid electrolyte body 12, a measurement gas-exposed electrode layer 13 affixed to an outer surface of the body 12, and an air-exposed electrode layer 14 affixed to an inner surface of the body 12. The solid electrolyte body 12 is formed by an oxygen iron-conductive sintered oxide made of ZrO₂, HfO₂, ThO₂, and Bi₂O₃ in which CaO, MgO, Y₂O₃, and Yb₂O₃ are mixed as stabilizers. The electrode layers 13 and 14 are each made of a noble metal such as platinum that is higher in catalytic activity and plated chemically with a porous film. The solid electrolyte body 12 has defined therein an air chamber 15 within which a heater 16 is disposed. The heater 16 is designed to produce thermal energy which is great enough to heat the whole of the sensor element 11 up to a desired activation temperature.

In use, the electrode layer 13 on the outer surface of the solid electrolyte body 12 is exposed to the exhaust gasses of the engine. The electrode layer 12 on the inner surface of the solid electrolyte body 12 is exposed to air admitted into the air chamber 15. The sensor element 11 works to produce an electromotive force between the electrode layers 13 and 14 as a function of a difference in oxygen concentration (i.e., a difference in partial pressure) between the exhaust gases and the air. Specifically, the sensor element 11 produces the electromotive force which is different in level between richness and leanness of the A/F ratio. The oxygen sensor 10 outputs an electromotive force signal as indicating the concentration of oxygen (O₂) in the exhaust gasses that is a function of the A/F ratio.

FIG. 3 is an electromotive force characteristic view which demonstrates the electromotive force, as produced by the sensor element 11, and the A/F ratio of the exhaust gasses of the engine. The horizontal axis represents an excess air ratio λ. λ=1 indicates the stoichiometric air-fuel ratio. A solid curve indicates the electromotive force, as produced by the sensor element 11, when the sensor element 11 is activated fully. In a rich range where the excess air ratio λ is smaller than one (1), the electromotive force will be approximately 0.9V. In a lean range where the excess air ratio λ is greater than one (1), the electromotive force will be approximately 0V.

The electromotive force usually changes with a change in temperature of the sensor element 11. For instance, when the temperature of the sensor element 11 (will also be referred to as a sensor element temperature below) drops, the electromotive force curve is shifted to a dashed line, as indicated by A in FIG. 3. Alternatively, when the sensor element temperature rises, the electromotive force curve is shifted to a dotted line, as indicated by B. Specifically, such shifts will cause the value of the electromotive force, as produced in the stoichiometric condition, to change from a correct one. This results in lowered feedback control accuracy in controlling the A/F ratio near the stoichiometric air-fuel ratio.

In order to alleviate the above problem, the gas concentration measuring apparatus of this embodiment is designed to measure the impedance of the sensor element 11 (will also be referred to as a sensor element impedance Zac below) that has a correlation with the temperature of the sensor element 11 and bring it into agreement with a target one to keep the sensor element 11 in a desired activated condition. The measurement of the sensor element impedance Zac is achieved by applying an ac voltage, whose level is swept to the positive and negative sides instantaneously, to one of the electrode layers 13 and 14 of the sensor element 11 and sampling a resultant change in voltage output of the sensor element 11 to determine the sensor element impedance Zac.

The heater 16 is controlled by, for example, a PWM system which may be designed to be compact in size. Specifically, the PWM system works to output a duty signal (i.e., a pulse signal) which specifies a given on/off duration of the heater 16 to control the amount of thermal energy to be produced by the heater 16.

Referring back to FIG. 1, the gas concentration measuring apparatus works as a sensor controller having the illustrated circuit structure. The oxygen sensor 10 is connected at an end thereof (i.e., the gas-exposed electrode layer 13 of the sensor element 11) to a resistor 21 and a low-pass filter 22. The electromotive force, as produced by the oxygen sensor 10 as a function of the concentration of oxygen in the exhaust gasses, is transmitted as an O₂ output to an A/D port of a microcomputer 100 through the low-pass filter 22. The microcomputer 100 works to analyze the O₂ output to make a determination of whether the A/F ratio is on the rich side or lean side.

The low-pass filter 22 works to remove electric noises and ac components from the input and minimize adverse effects on the O₂ output which arise from sweeping of voltage, as described later in detail, applied to the oxygen sensor 10 in an ac form to measure the sensor element impedance Zac.

The gas sensor measuring apparatus is also equipped with an impedance measuring circuit joined to the end of the oxygen sensor 10. The impedance measuring circuit has an ac voltage source 23, a divider resistor (i.e., a voltage divider) 24, and a coupling capacitor 25 connected in series. To a junction between the coupling capacitor 25 and the oxygen sensor 10, a serial circuit made up of a high-pass filter 26, a peak hold circuit 27, and an amplifier 28 is connected. In the following discussion, the output voltage of the ac voltage source 23 will be expressed by Va. The voltage appearing at one of terminals leading to the divider resistor 24 will be expressed by Vb. The voltage appearing at the other terminal of the divider resistor 24 will be expressed by Vc. The output voltage of the high-pass filter 26 will be expressed by Vd. The output voltage of the amplifier 28 will be expressed by Ve. The voltage Vc is developed by the electromotive force as a function of an instantaneous value of the concentration of oxygen, as measured by the oxygen sensor 10 in an oxygen measuring mode, as will be described later. The voltage Vc is, as described above, at approximately 0.9V when the exhaust gasses are on the rich side and at approximately 0V when the exhaust gasses are on the lean side. The divider resistor 24 has a resistance value R.

The peak hold circuit 27 is made up of an input comparator to which the voltage Vc is inputted and a capacitor joined at an end to the comparator and at the other end to ground. The peak hold circuit 27 works to hold the peak of the voltage Vc inputted thereto. The peak hold circuit 27 also includes a low-pass filter to remove electric noises added to the input which arise from a change in magnetic flux propagated to a sensor harness tied together with a heater cable resulting from a change in current supplied to the heater 16 caused by an on/off switching operation of the PWM system to control the on-duration of the heater 16 in the heater control mode.

The ac voltage source 23 is responsive to a command signal from the microcomputer 100 to sweep the level of voltage Va to the positive and negative side at a given frequency. Such a change in level of the voltage Va results in a flow of current through a circuit path extending from the divider resistor 24, the coupling capacitor 25, and the oxygen sensor 10. This causes the voltage Vc, as developed at the terminal of the oxygen sensor 10, to change to a fraction thereof given as a function of the impedance of the oxygen sensor 10 and the resistance value R of the divider resistor 24. The voltage Vc is then sampled in the A/D port of the microcomputer 100 as the sensor element impedance indicative voltage Ve through the high-pass filter 26, the peak hold circuit 27, and the amplifier 28.

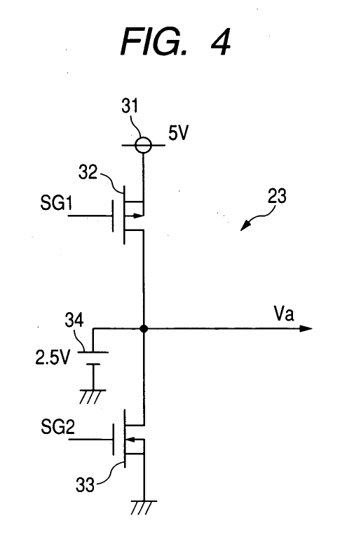

The ac voltage source 23 has a circuit structure, as illustrated in FIG. 4, which includes a power supply 31, transistors 32 and 33, and a reference voltage source 34. The transistor 32 is a p-channel MOSFET. The transistor 33 is an n-channel MOSFET. The transistors 32 and 33 are connected in series. The reference voltage source 31 is joined to a junction of the transistors 32 and 33. The power supply 31 works to provide 5V. The reference voltage source 34 works to provide 2.5V. Binary signals SG1 and SG2 of a high or low level are outputted from the microcomputer 100 to gates of the transistors 32 and 33. When the impedance measuring mode is entered, the microcomputer 100 outputs the signals SG1 and SG2 to turn on the transistors 32 and 33 alternately. Specifically, the microcomputer 100 outputs the signal SG1 of the low level to the gate of the transistor 32 to turn on it, so that the output voltage Va of the ac voltage source 23 rises to 5V, as produced by the power supply 31. Subsequently, the microcomputer 100 outputs the signal SG2 of the high level to the gate of the transistor 33 to turn on it, so that the output voltage Va of the ac voltage source 23 drops to the ground level.

The sensor element impedance Zac is given by the following relation.
Zac=Vc/{(Va−Vc)/R} (1)

The voltage Va and the resistance R are fixed values if the on-resistance of the transistor 32 is ignored. The determination of the sensor element impedance Zac may, therefore, be achieved by measuring only the voltage Vc. Specifically, the microcomputer 100 samples the voltage Vc through the high-pass filter 26, the peak hold circuit 27, and the amplifier 28 and calculates the sensor element impedance Zac.

The frequency of the voltage Va, as produced by the ac voltage source 23, must be selected to be greater than a change in concentration of oxygen in the exhaust gasses and may be determined in the following manner. The frequency at which the voltage Va is swept in level is preferably higher than or equal to 10 kHz in terms of frequency characteristics of the impedance of the sensor element 11, but preferably lower than 30 kHz in terms of use of the peak hold circuit 27. Such a sweeping frequency is also preferably lower than 500 kHz that is insensitive to resistances of wires making up the current path. For these reasons, the sweeping frequency is found to be most preferably on the order of 10 kHz.

As the resistance value R of the divider resistor 24 is higher, it impedes the flow of current greatly, thus resulting in a delay in charging the coupling capacitor 25. The change in voltage Vc following a change in voltage Va, therefore, undergoes a delay, thus facilitating ease of measurement of the voltage Vc. Additionally, the greater the resistance value R, the smaller adverse effects of variability of the coupling capacitor 25 or the MOSFETs in the ac voltage source 23 and of the resistances of wires on the circuit board will be. For instance, the resistance value R is preferably higher than or equal to 500 Ω. Too great the resistance value R, however, results in a decreased in resolution of measurement of the sensor element impedance Zac. The resistance value R is, thus, selected preferably in terms of the trade-off between the resolution and the accuracy in measuring the sensor element impedance Zac. In this embodiment, the resistance value R of the divider resistor 24 is selected to be 1 kΩ.

The capacity of the coupling capacitor 25 is preferably within a range of 0.1 to 1 μF in terms of effects on the O₂ output and more preferably less than 0.2 μF in terms of cost and size thereof. The greater the capacity is, however, the more effective it is to measure the sensor element impedance Zac. In this embodiment, the capacity of the coupling capacitor 25 is 0.1 μF.

The difference between when the voltage appearing at the end of the oxygen sensor 10 (i.e., the voltage Vc) is measured, as described above, upon application of ac voltage to the oxygen sensor 10 and when the voltage at a current measuring resistance, as used in conventional impedance measurement systems for A/F sensors, is measured upon application of ac voltage to the oxygen sensor 10 will be discussed below.

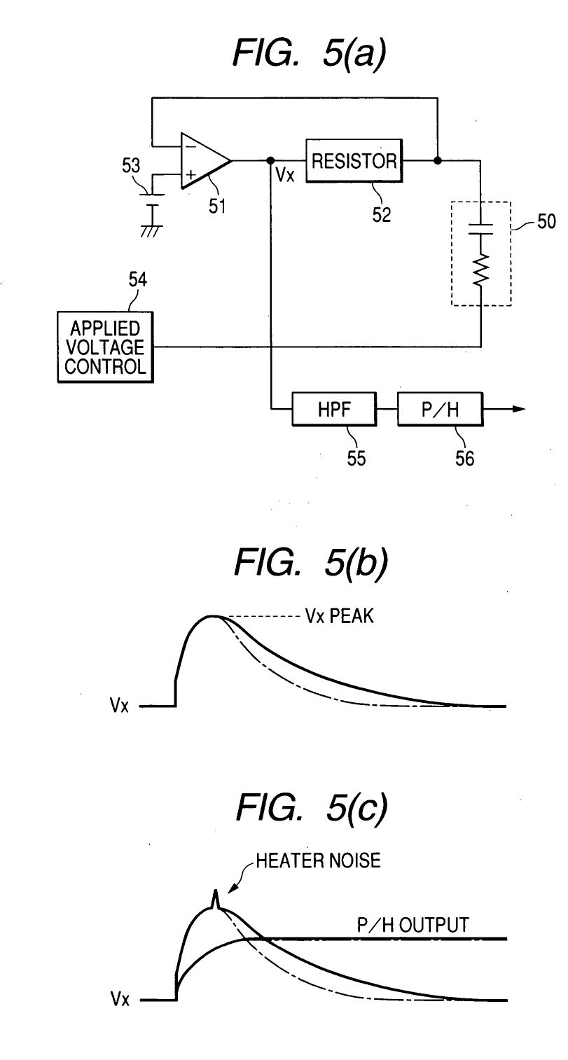

FIG. 5(a) illustrates an example of a circuit structure of the conventional impedance measurement systems which includes a reference power supply 53, an operational amplifier 51, and a current measuring resistor 52 which are connected in series to an end of an A/F sensor 50. The system also includes an applied voltage control circuit 54 connected to the other end of the A/F sensor 50, a high-pass filter 55, and a peak hold circuit 56. The current flowing out of the A/F sensor 50 passes through the current measuring resistor 52 and is sampled in the form of the voltage Vx appearing at the end of the resistor 52. The voltage Vx is then inputted to a microcomputer (not shown) through the high-pass filter 55 and the peak hold circuit 56. When it is required to measure the impedance of the A/F sensor 50, the applied voltage control circuit 54 sweeps the voltage to be applied to the A/F sensor 50 in the ac form. A resultant change in current flowing through the A/F sensor 50 is measured by sampling the voltage Vx developed at a junction between the operational amplifier 51 and the current measuring resistor 52.

The sweeping of the voltage applied to the A/F sensor 50 in the ac form results in a change in the voltage Vx, as demonstrated in FIG. 5(b). The peak of the voltage Vx has a correlation to the impedance of the A/F sensor 50, thus enabling the impedance to be determined accurately by sampling the peak. The locus of convergence of the voltage Vx usually depends upon the capacity of the A/F sensor 50. The capacity of the A/F sensor 50 is individually variable and usually decreases with age, which accelerates, as indicated by a dashed line, the convergence of the voltage Vx.

An electric noise, as arising from the operation of the heater 16, may be added, as demonstrated in FIG. 5(c), to the voltage Vx, thus requiring the need for a low-pass filter to remove the noise.

However, when the constant of the low-pass filter is increased to a value great enough to remove such a heater noise, it will cause the output of the peak hold circuit 56 to be varied by a variation in the voltage Vx during convergence thereof arising from the individual variability of the capacity of the A/F sensor 50. This will result in decreased accuracy in measuring the impedance of the A/F sensor 50.

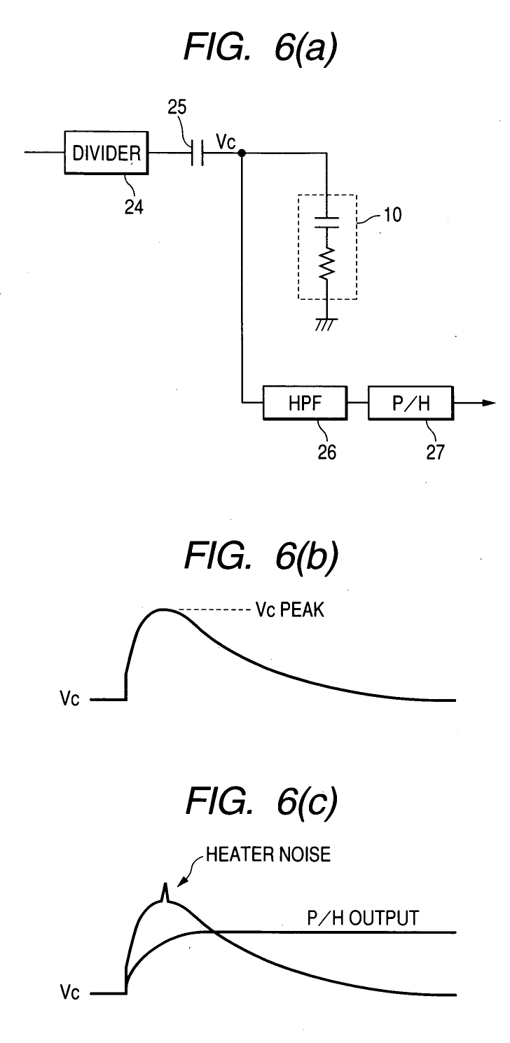

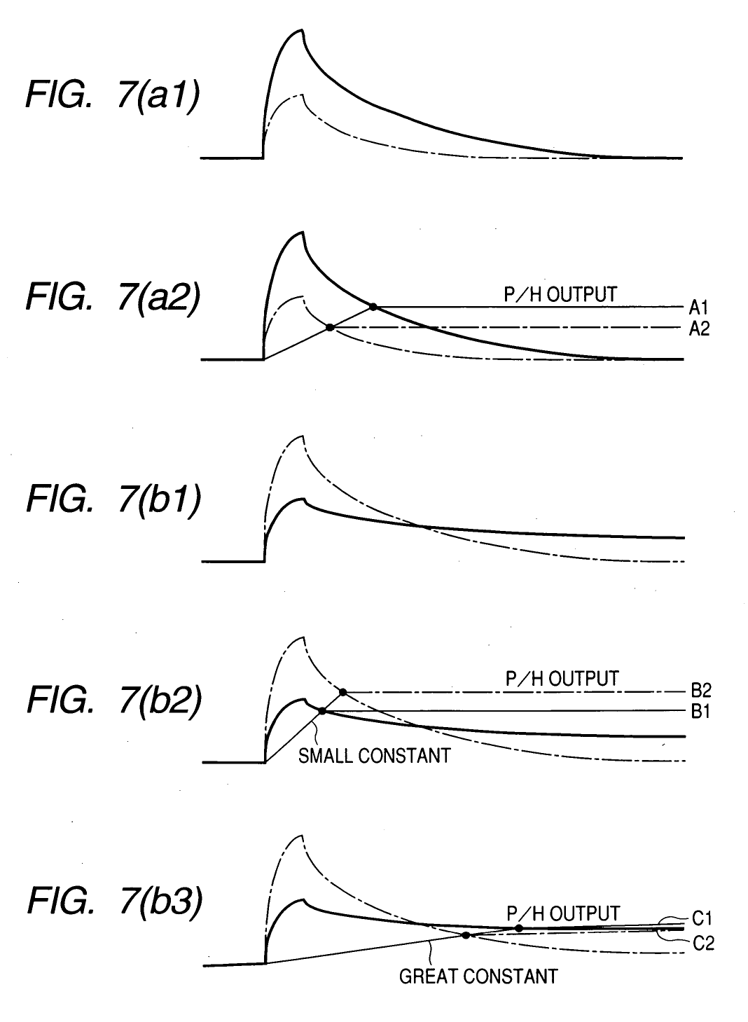

The gas concentration measuring apparatus of this embodiment, as clearly shown in FIG. 6(a), is so designed that the voltage Vc appearing at the end of the oxygen sensor 10 is sampled by the microcomputer 100 through the high-pass filter 26 and the peak hold circuit 27. The voltage Vc has, as described above, a correlation of the peak thereof to the sensor element impedance Zac and is insensitive to the capacity of the oxygen sensor 10 during the convergence thereof, thus ensuring the stability of accuracy in determining the sensor element impedance Zac using the voltage Vc.

Particularly, the coupling capacitor 25 is much smaller in capacity than the sensor element 11, so that the convergence of the voltage Vc depends largely upon the speed at which the coupling capacitor 25 is charged. The voltage Vc is, therefore, insensitive to the individual variability or aging of the sensor element 11, thereby ensuring the accuracy in determining the sensor element impedance Zac.

For instance, in the case where the capacity of the sensor element 11 is approximately 1000 μF in mint condition and 100 μF in aged condition, the capacity of the coupling capacitor 25 is selected preferably to be within a range of 0.1μ to 1 μF. Even if the coupling capacitor 25 experiences a capacity variation of ±10% and a temperature characteristic variation of ±15%, the capacity of the coupling capacitor 25 is much smaller than that of the sensor element 11. Usually, a measured value of the voltage Vc contains an error arising from the individual variability of the circuit of FIG. 6(a), but it is much smaller than that caused by the individual variability or aging of the sensor element 11, thus ensuring the accuracy in determining the sensor element impedance Zac.

Next, the difference when the voltage appearing at the end of the oxygen sensor 10 (i.e., the voltage Vc) is measured upon application of ac voltage to the oxygen sensor 10 in the structure of FIG. 6(a) and when the voltage appearing across the divider resistor 24 upon application of ac voltage to the oxygen sensor 10 in the structure of FIG. 6(a) will be studied below.

FIGS. 7(a1) and 7(a2) illustrate for the case where the voltage Vc appearing at the end of the oxygen sensor 10 is sampled. FIGS. 7(b1), 7(b2), and 7(b3) illustrate for the case where the voltage appearing across the divider resistor 24 is sampled. In the drawing, solid lines indicate waveforms of the voltages when the impedance of the oxygen sensor 10 is higher. Dashed lines indicates waveforms of the voltages when the impedance of the oxygen sensor 10 is lower.

FIG. 7(a1) shows that when the impedance of the oxygen sensor 10 is higher, the voltage Vc at the end of the oxygen sensor 10 has a greater peak, and the amount of current flowing through the oxygen sensor 10 decreases, thus resulting in a decreased rate at which the voltage Vc converges and that when the impedance of the oxygen sensor 10 is lower, the voltage Vc at the end of the oxygen sensor 10 has a smaller peak, and the amount of current flowing through the oxygen sensor 10 increases, thus resulting in an increased rate at which the voltage Vc converges. FIG. 7(a2) shows that the output of the peak hold circuit 27 has a greater value A1 when the impedance of the oxygen sensor 10 is higher and it has a smaller value A2 when the impedance of the oxygen sensor 10 is lower. The output of the peak hold circuit 27 has a correlation to the impedance of the oxygen sensor 10 without regard to the constant of a low-pass filter built therein, thus ensuring the accuracy in determining the sensor element impedance Zac.

FIG. 7(b 1) shows that when the impedance of the oxygen sensor 10 is higher, the voltage developed across the divider resistor 24, unlike FIG. 7(a1), has a smaller peak, and the amount of current flowing through the oxygen sensor 10 decreases, thus resulting in a decreased rate at which the voltage converges, and that when the impedance of the oxygen sensor 10 is lower, the voltage has a greater peak, and the amount of current flowing through the oxygen sensor 10 increases, thus resulting in an increased rate at which the voltage converges. In this case, unlike the case of FIG. 7(a1), the magnitude relation of the output of the peak hold circuit 27 to the impedance of the oxygen sensor 10 is reversed in voltage level depending upon the constant of a low-pass filter built in the peak hold circuit 27, thus leading to a change in correlation between the output of the peak hold circuit 27 and the impedance of the oxygen sensor 10. Specifically, as demonstrated in FIGS. 7(b2) and 7(b3), when the constant of the low-pass filter is smaller, a relation of B1<B2 is met, while when the constant of the low-pass filter is greater, a relation of C1>C2 is met. B1 and C1 represent the output of the peak hold circuit 27 when the impedance of the oxygen sensor 10 is greater. B2 and C2 represent the output of the peak hold circuit 27 when the impedance of the oxygen sensor 10 is smaller.

The comparison between the above two cases shows that the use of the voltage Vc appearing at the terminal of the oxygen sensor 10 is more suitable for measuring the sensor element impedance Zac in terms of the accuracy.

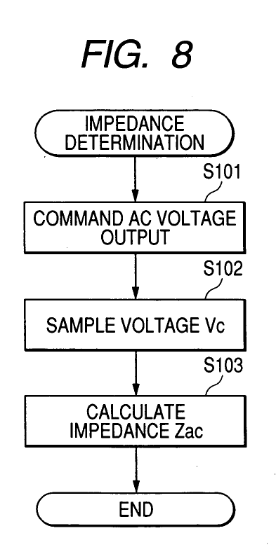

FIG. 8 is a flowchart of a sequence of logical steps or program to be executed by the microcomputer 100 in the impedance measuring mode at a regular interval of, for example, 128 msec.

After entering the program, the routine proceeds to step 101 wherein an ac voltage output command signal is outputted to the ac voltage source 23. The ac voltage source 23 then sweeps the voltage Va to the positive and negative sides at a given frequency.

The routine proceeds to step 102 wherein the value of the voltage Vc (i.e., the output Ve of the amplifier 28) is sampled when the output voltage Va is being swept to the positive side. The routine proceeds to step 103 wherein the sensor element impedance Zac is calculated using the sampled value of the voltage Vc according to Eq. (1), as discussed above.

The microcomputer 100 monitors the sensor element impedance Zac, as determined in the above manner, to feedback-control the energization of the heater 16 using any known techniques. For instance, the microcomputer 100 calculates a difference between the sampled value of the sensor element impedance Zac and a target one (corresponding to a target temperature of the sensor element 11) and determines the on-duration of the heater 16 (e.g., a duty cycle of a heater on/off signal) based on that difference under the so-called PID control.

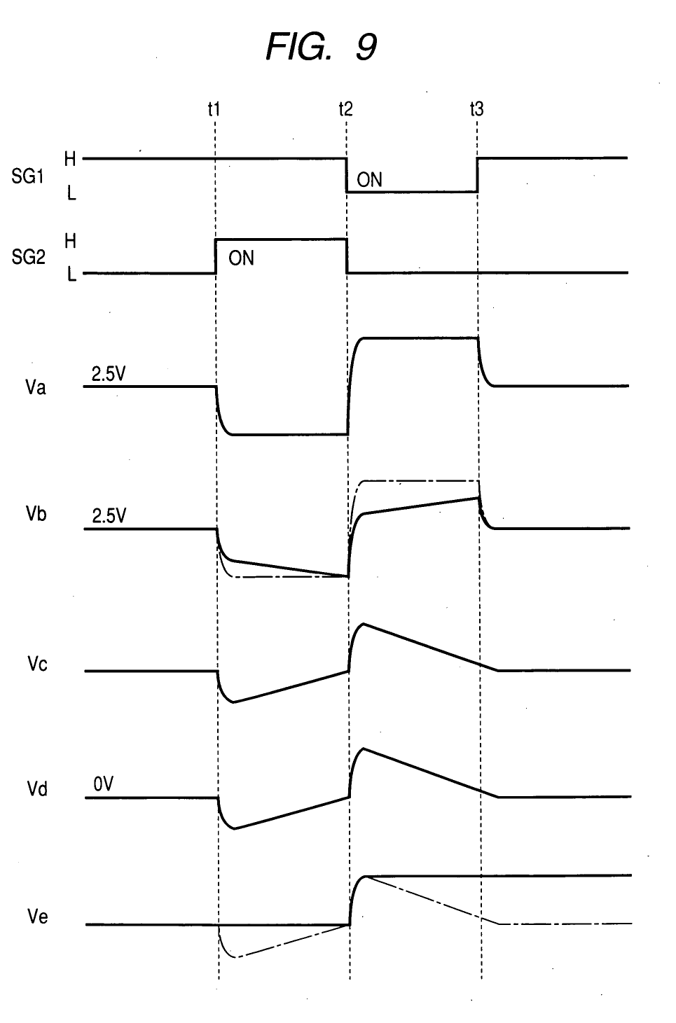

FIG. 9 illustrates waveforms of the on/off signals SG1 and SG2 outputted to the transistors 32 and 33 of the ac voltage source 23 and the voltages Va, Vb, Vc, Vd, and Ve, as discussed in FIG. 1, in the impedance measuring mode.

Before time t1, the microcomputer 100 is in the oxygen measuring mode. The voltage Vc at the terminal of the oxygen sensor 10 is developed by the electromotive force, as produced by the oxygen sensor 10. The on/off signal SG1 is in the high level, while the on/off signal SG2 is in the low level. This causes the transistors 32 and 33 to be both in the off-state, so that the voltages Va and Vb are at 2.5V.

When time t1 is reached, the microcomputer 100 switches the on/off signal SG2 to the high level to turn on the transistor 33, so that the voltage Va changes to the negative side (i.e., 0V). This causes the current that is a function of the impedance of the sensor element 11 to flow through the current path including the divider resistor 24, the coupling capacitor 25, and the oxygen sensor 10, thus resulting in changes in the voltages Vb and Vc. The voltage Va to be applied to the oxygen sensor 10 may be swept regardless of whether the electromotive force of the oxygen sensor 10 is at either of 0V or 0.9V. The voltage Vc is changed to have a level that is a fraction thereof given by a ratio of the resistance value R to a total of the resistance value R and the impedance of the oxygen sensor 10. Immediately after being changed, the voltages Vb and Vc will once have a level corresponding to the impedance of the oxygen sensor 10, after which the voltage Vb will drop, while the voltage Vc will rise following charging of the coupling capacitor 25. A dashed line, as extending along with the Vb curve, indicates a change in the voltage Va.

When time t2 is reached, the microcomputer 100 returns the on/off signal SG2 to the low level to turn off the transistor 33 and switches the on/off signal SG1 to the high level to turn on the transistor 32, so that the voltage Va changes to the positive side (i.e., 5V). This causes the current that is a function of the impedance of the sensor element 11 to flow through the current path including the divider resistor 24, the coupling capacitor 25, and the oxygen sensor 10 in a direction reverse to that when the voltage Va is swept to the negative side, thus resulting in changes in the voltages Vb and Vc. The voltage Vc is sampled by the peak hold circuit 27 and used in the microcomputer 100 to determine the sensor element impedance Zac. Immediately after being changed, the voltages Vb and Vc will once have a level corresponding to the impedance of the oxygen sensor 10, after which the voltage Vb will rise, while the voltage Vc will drop following charging of the coupling capacitor 25.

When time t3 is reached, the microcomputer 100 switches the on/off signal SG1 back to the high level to turn off the transistor 32 and returns to the oxygen measuring mode.

As apparent from the above discussion, the gas concentration measuring apparatus of this embodiment is designed to have the coupling capacitor 25 disposed in series in the current path through which the ac voltage is applied to the oxygen sensor 10 to measure the sensor element impedance Zac, thereby enabling a desired change in the voltage Va to be given to the oxygen sensor 10 regardless of the electromotive force, as produced by the oxygen sensor 10. Specifically, it is possible for the microcomputer 100 to sweep the voltage Va in the ac form without distortion of the polarization which usually occurs in the oxygen sensor 10 in the impedance measuring mode. This ensures the accuracy in measuring the sensor element impedance Zac without sacrificing the output of the oxygen sensor 10.

The oxygen sensor 10 is designed to use the same cell in measuring the concentration of oxygen and the sensor element impedance Zac. The measurement of the sensor element impedance Zac is usually performed during the measurement of the concentration of oxygen. There is, therefore, a greater concern about adverse effects of the alternating change in voltage Va used in measuring the sensor element impedance Zac on the measurement of the concentration of oxygen. The coupling capacitor 25, however, works in the nature of its activity to allow the alternating change in voltage Va to pass therethrough, but block a dc current. Further, the frequency of the alternating change in voltage Va is greater than a change in concentration of oxygen. This minimizes the above adverse effects on the measurement of the concentration of oxygen.

Particularly, the measurement of the sensor element impedance Zac is achieved by sampling the voltage Vc appearing at the terminal of the oxygen sensor 10 following the change in voltage Va. This causes the voltage Vc to have, unlike the impedance measuring system, as taught in, for example, Japanese Patent First Publication No. 63-140955, a correlation to the sensor element impedance Zac during the convergence thereof, thereby ensuring the accuracy in determining the sensor element impedance Zac.

Additionally, the capacity of the coupling capacitor 25 is, as described above, much smaller than that of the sensor element 11, thus ensuring the accuracy in determining the sensor element impedance Zac regardless of a change in capacity of the sensor element 11 arising from the individual variability or aging thereof.

The determination of the sensor element impedance Zac may also be achieved by using the value of the voltage Vc, as sampled during the convergence thereof, thereby eliminating the need for sampling the peak of the voltage Vc. This permits the constant (i.e, the degree of smoothing) of the low-pass filter built in the peak holed circuit 27 to be increased in order to eliminate the heater noise.

The voltage Vc appearing at the terminal of the oxygen sensor 10 is sampled when, after first being swept by the ac voltage source 23 to one of the positive and negative sides, the voltage Va is swept to the other side, thereby enabling a great resulting change in the voltage Vc to be derived which increases the resolution at which the sensor element impedance Zac is determined.

The use of the sensor element impedance Zac, as determined in the above manner, improves the controllability of the heater 16, thereby ensuring the stability of the output of the oxygen sensor 10. This increases the accuracy of the air-fuel ratio feedback control, thereby improving exhaust emissions of the engine.

The sensor element impedance Zac is, as described above, determined using the voltage Vc developed at the terminal of the oxygen sensor 10 and the resistance value R of the divider resistor 24 during the application of the alternating change in the voltage Va to the oxygen sensor 10, but may be calculated by the voltage Vc and a combination of resistance values of the divider resistor 24 and the coupling capacitor 25 according to the following equation.
Zac=Vc/{(Va−Vc)/(R+Zc)} (2)
where Zc is the impedance of the coupling capacitor 25 and given by a relation of Zc=½πfC where f is the frequency, and C is the capacity.

The use of Eq. (2) compensates for an error of the sensor element impedance Zac arising from the resistance of wires in the circuit, thereby improving the accuracy in determining the sensor element impedance Zac.

It is also possible to compensate for an error in determining the sensor element impedance Zac arising from an on-resistance of the transistor of the ac voltage source 23. Specifically, if the voltage, as produced by the power supply 31, as illustrated in FIG. 3 is defined as Vcc, and the on-resistance of the high-side transistor (MOSFET) 32 is defined as Ron, the sensor element impedance Zac may be given by the following equation.
Zac=Vc/{(Vcc−Vc)/(Ron+R+Zc)} (3)

When the sensor element impedance Zac is determined in view of the on-resistance Ron of the transistor 32, the resistance value R of the divider resistor 24, and the resistance (i.e., the impedance Zc) of the coupling capacitor 25, the individual variability and a variation in temperature behavior of these elements will contribute to an error in determining the sensor element impedance Zac. In general, inexpensive film resistors have smaller variations in resistance of ±5% caused by the individual variability and ±200 ppm/° C. caused by a variation in temperature behavior thereof. In contrast, MOSFETs have variations in on-resistance of ±5% caused by the individual variability and 100% caused by a variation in temperature behavior thereof. Surface-mounting ceramic coupling capacitors have variations in resistance of ±10% caused by the individual variability and ±15% caused by a variation in temperature behavior thereof. Specifically, the on-resistance of the MOSFETs and the impedance of the coupling capacitors each have a great variation. Therefore, the resistance value R of the divider resistor 24 is selected preferably to be much greater than those of the transistor 32 and the coupling capacitor 25 in order to improve the accuracy in determining the sensor element impedance Zac. However, too great a resistance value R of the divider resistor 24 results in a decreased value of the voltage Vc appearing at the terminal of the oxygen sensor 10, thereby leading to a reduction in resolution at which the sensor element impedance Zac is determined. The resistance value R of the divider resistor 24 is, therefore, selected preferably in terms of the trade-off between the resolution and the accuracy in measuring the sensor element impedance Zac. For instance, in the case where the on-resistance of the transistor (MOSFET) 32 is on the order of 30 Ω, the impedance of the coupling capacitor 25 is on the order of 159 Ω, and the sensor element impedance Zac is on the order of 15 Ω, the resistance value R of the divider resistor 24 is selected preferably from a range of 100 to 500 Ω.

The coupling capacitor 25 may alternatively be disposed in series between the divider resistor 24 and the ac voltage source 23 in the circuit, as illustrated in FIG. 1. This also improves, like the structure of FIG. 1, the accuracy in determining the sensor element impedance Zac and minimizes the heater noises.

The microcomputer 100 is, as described above, designed to sweep the voltage Va outputted from the ac voltage source 23 to the negative side and the positive side in sequence, but may sweep it in a reverse order.

The peak hold circuit 27 is, as described above, equipped with the low-pass filter made up of a resistor component and a capacitor component built therein in order to eliminate the heater noise, but however, a discrete low-pass filter may alternatively be installed between the peak holder circuit 27 and the high-pass filter 26.

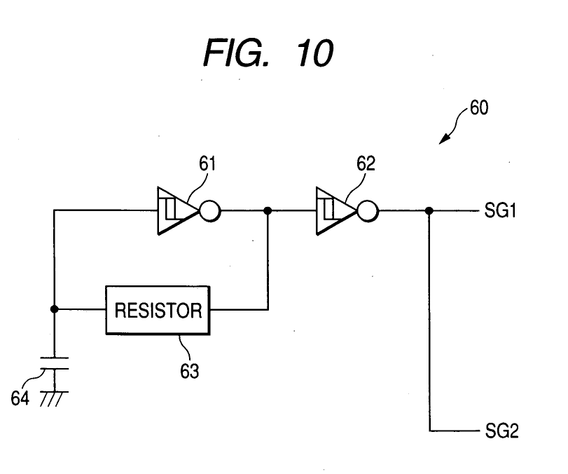

A self-excited oscillator using Schmitt-trigger inverters may be employed to apply the alternating voltage Va to the oxygen sensor 10 to measure the sensor element impedance Zac. FIG. 10 illustrates an example of such a circuit structure. The self-excited oscillator 60 includes the Schmitt-trigger inverters 61 and 62, the resistor 63, and the capacitor 64. The inverter 62 works to output the on/off signals SG1 and SG2 to, for example, the transistors 32 and 33, as illustrated in FIG. 4, to produce the alternating voltage Va.

Typical systems to measure the impedance of A/F sensors are engineered to reset the peak hold circuit a given period of time after completion or before initiation of sweeping of the voltage applied to the A/F sensor in order to minimize adverse effects of the measurement of the impedance on an output of the A/F sensor. The resetting is achieved by turning on a transistor installed in parallel to a capacitor built in the peak hold circuit to discharge the capacitor. The sensor control circuit, as described in the above embodiment, is not required to reset the output of the peak hold circuit 27 to zero (0V) every time the impedance measuring mode is entered. A system may, thus, be employed which is equipped with a resistor instead of the transistor and pulls down the transistor to discharge the capacitor in the peak hold circuit.

The gas concentration measuring apparatus is designed to measure the sensor element impedance Zac by applying the alternating voltage to the sensor element 10, but however, such measurement may alternatively be achieved by applying an alternating current to the oxygen sensor 10 in a similar manner as described above.

The oxygen sensor 10 may alternatively be designed to have an laminated sensor element or made up of an electromotive force output cell and a sensor cell working to sense another type of gas. For example, a two-cell A/F sensor made up of an electromotive force output cell and an oxygen concentration sensor cell may be employed. In this case, the sensor element impedance Zac is the impedance of the electromotive force output cell.

Referring back to FIG. 5(a), the current measuring resistor 52 made of a shunt resistor is joined to the A/F sensor 50. The concentration of oxygen (i.e., the A/F ratio) is, as described above, determined as a function of current flowing through the shunt resistor 52. The impedance of the A/F sensor 50 is measured by sweeping the voltage applied to the A/F sensor 50 and sampling a resulting change in current flowing through the shunt resistor 52.

The current flowing through the shunt resistor 52 is within a range of −1.5 mA to 2.5 mA in the oxygen measuring mode and within a range of 10 mA in the impedance measuring mode that is more than five times that in the oxygen measuring mode. The current is determined by sampling the voltage developed at the end of the shunt resistor 52. In the case where the voltage developed at the end of the shunt resistor 52 is inputted directly to an amplifier or an A/D converter, sampling the voltage within level ranges of currents flowing out of the A/F sensor 50 both in the oxygen measuring mode and the impedance measuring mode requires selection of the capacity of the shunt resistor 52 in light of a higher one of the level ranges (i.e., the level range in the impedance measuring mode). Such selection requires the measurement of the concentration of oxygen in a widened range, thus resulting in a difficulty in increasing the measurement resolution.

The above drawback may be alleviated by sampling the voltage developed at the end of the A/F sensor 50 to measure the impedance of the A/F sensor 50.

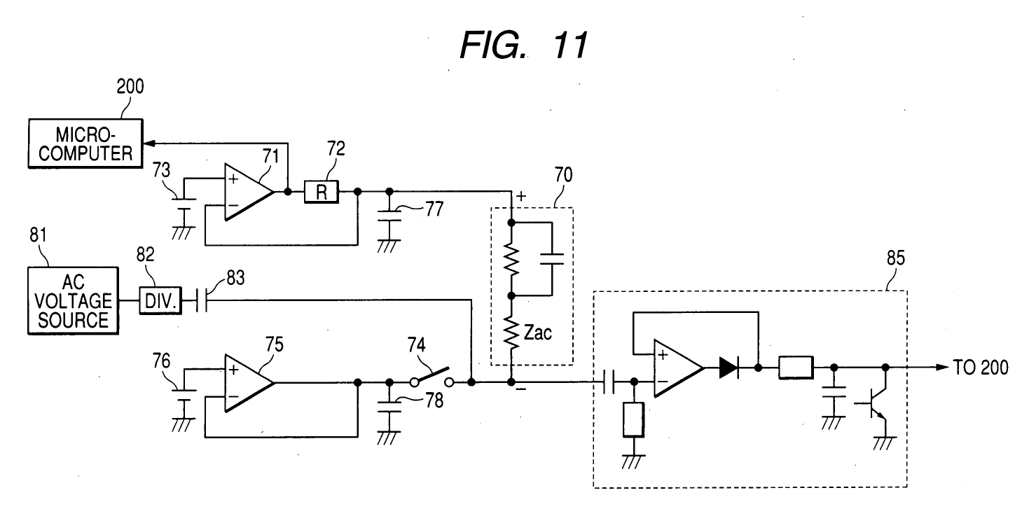

FIG. 11 illustrates an example of an A/F sensor drive circuit which is designed to avoid the above problem.

The reference power supply 73 is connected to a positive (+) terminal of the sensor element 70 through the operational amplifier 71 and the current measuring resistor 72. The reference power supply 76 and the operational amplifier 75 are connected to a negative terminal (−) of the sensor element 70 through the switch 74. The reference power supplies 73 and 76 and the operational amplifiers 71 and 75 make up a voltage applying circuit. For instance, the reference power supply 73 is designed to provide 2.2V. The reference power supply 76 is designed to provide 1.8V. The capacitors 77 and 78 are joined to the positive and negative terminals of the sensor element 70 for ESD (electro static discharge) protection. The reference power supply 76 may be designed to apply the voltage to the sensor element 70 at a variable level selected as a function of an instantaneous value of the current flowing through the sensor element 70.

To the negative terminal of the sensor element 70, the ac voltage source 81, the divider resistor 82, and the coupling capacitor 83 are joined in series. The impedance measurement output circuit 85 is also joined to the negative terminal of the sensor element 70. The impedance measurement output circuit 85, like in FIG. 1, includes a high-pass filter, a peak hold circuit, and an amplifier.

A desired measurement of the impedance of the sensor element 70 may be derived by selecting the capacity of the ESD protection capacitor 78 leading to the negative terminal of the sensor element 70 to be smaller than that of the coupling capacitor 83. The EDS protection capacitor 77 joined to the positive terminal of the sensor element 70 may have any capacity. For instance, the static capacity of the coupling capacitor 83 is 0.33 μF. The static capacities of the ESD protection capacitors 77 and 78 are 0.033 μF. The operational amplifiers 71 and 75 joined to the sensor element 70 serve to eliminate adverse effects of the capacity of the ESD protection capacitor 77 leading to the positive terminal of the sensor element 70. The operational amplifiers 71 and 75 may be omitted. In this case, the capacity of the ESD protection capacitor 77 is selected preferably to be greater than that of the coupling capacitor 83 for fine measurement of the impedance of the sensor element 70.

When the oxygen measuring mode is entered to determine the A/F ratio, the switch 74 is placed in a closed state. The reference power supplies 73 and 76 apply the voltage to the sensor element 70. This causes the current to flow in the sensor element 70 as a function of concentration of oxygen in exhaust gasses in the engine. The microcomputer 200 samples the current flowing out of the sensor element 70 in the form of voltage appearing at the end of the current measuring resistor 72 and determine the A/F ratio of the exhaust gasses.

When the impedance measuring mode is entered during execution of the oxygen measuring mode, the microcomputer 200 opens the switch 74 to block the application of voltage to the sensor element 70 from the reference power supply 76. The ac voltage source 81 sweeps the voltage to be applied across the sensor element 70 at a given frequency. This causes the voltage appearing at the negative terminal of the sensor element 70 to change as a function of the impedance of the senor element 70 (i.e., the sensor element impedance Zac). The impedance measurement output circuit 85 samples the voltage from the negative terminal of the sensor element 70 and outputs it to the microcomputer 200. The microcomputer 200 calculates the sensor element impedance Zac using the input.

Specifically, the measurement of the sensor element impedance Zac is achieved by sampling the voltage developed at the end of the sensor element 70 apart from the current measuring resistor 72 as used to determine the A/F ratio. This permits the capacity of the current measuring resistor 72 to be selected from within a range corresponding to that of current produced by the sensor element 70 as a function of the A/F ratio (i.e., the concentration of oxygen), thereby enabling the current produced by the sensor element 70 within, for example, a range of −1.5 mA to 2.5 mA to be measured over a voltage range of the operational amplifier or an input voltage range of an A/D converter of the microcomputer 200. This permits the resolution at which the A/F ratio is determined to be increased.

The above structure designed to measure the sensor element impedance Zac using the voltage at the end of the sensor element 70 is not required to sample the peak of the voltage, thus enabling the sensor element impedance Zac without being sacrificed by a low-pass filter as used to eliminate the heater noise or any other electric noises.

In the impedance measuring mode, the application of the voltage from the reference power supply 76 to the sensor element 70 is as described above, blocked by opening the switch 74, thereby ensuring the stability in determining the sensor element impedance Zac.

The structure of FIG. 11 may be designed to use feedback techniques to monitor an instantaneous value of the current flowing out of the sensor element 70 to control the voltage to be applied to the sensor element 70. In this case, the voltage applying circuit made up of the reference power supplies 73 and 76 and the operational amplifiers 71 and 75 may work to cancel a change in voltage to be applied to the sensor element 70, as produced by the ac voltage source 81, the divider resistor 82, and the coupling capacitor 83. This problem, however, is eliminated completely by the activity of the switch 74 to block the application of the voltage from the reference power supply 76 to the sensor element 70.

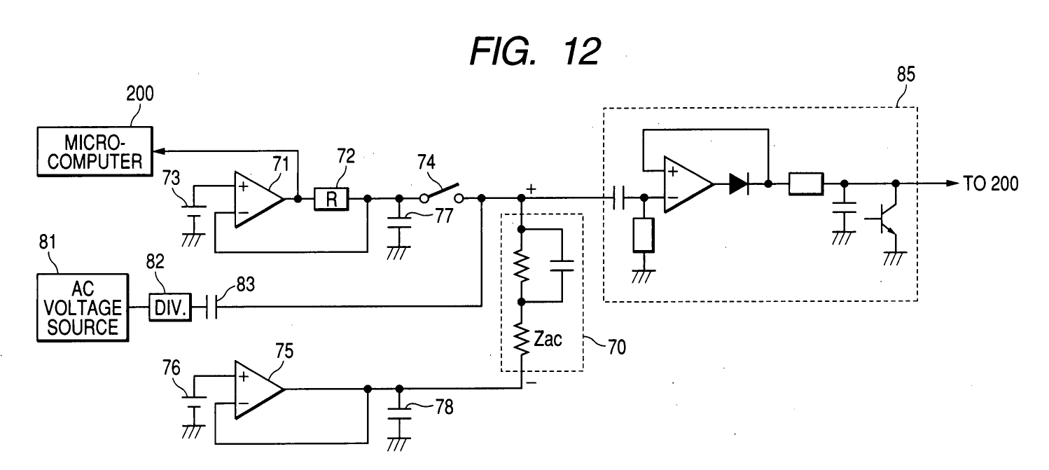

The structure of FIG. 11 has the ac applying circuit made up of the ac voltage source 81, the divider resistor 82, and the coupling capacitor 83 connected to one of the terminals of the sensor element 70 to which the current measuring resistor 72 is not joined, but however, may be so designed, as illustrated in FIG. 12, to have the ac applying circuit joined to the other (i.e., the positive terminal) of the sensor element 70 to which the current measuring resistor 72 is joined.

Specifically, the operational amplifier 71, the current measuring resistor 71, and the reference power supply 73 are coupled to the positive terminal of the sensor element 70 through the switch 74. The operational amplifier 75 and the reference power supply 76 are coupled to the negative terminal of the sensor element 70. The ac applying circuit made up of the ac voltage source 81, the divider resistor 82, and the coupling capacitor 83 is connected to a junction between the switch 74 and the positive terminal of the sensor element 70. The impedance measuring circuit 85 is also connected to the positive terminal of the sensor element 70. Other arrangements are identical with those in FIG. 11, and explanation thereof in detail will be omitted here.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A sensor impedance measuring apparatus comprising:
a circuit line extending through a gas sensor equipped with a sensor element which includes a solid electrolyte body and a pair of electrodes affixed to opposed surfaces of the solid electrolyte body, the sensor element working to produce an electromotive force as a function of concentration of oxygen contained in a gas;
an ac applying circuit disposed in a current path that is a portion of said circuit line and leads to one of the electrodes of the sensor element, said ac applying circuit working to applying one of an alternating voltage and an alternating current swept in level to a positive and a negative side to the sensor element;
a storage device installed in said ac applying circuit, said storage device working to block a flow of direct current and store charges therein;
a voltage sampling circuit working to sample a voltage developed between the sensor element and said ac applying circuit; and
an impedance determining circuit working to determine an impedance of the sensor element as a function of a value of the voltage sampled by said voltage sampling circuit while the one of the alternating voltage and the alternating current is being applied by said ac applying circuit to the sensor element.

2. A sensor impedance measuring apparatus as set forth in claim 1, wherein said storage device is made up of a resistor device and a capacitor device which are connected in series.

3. A sensor impedance measuring apparatus as set forth in claim 2, wherein said impedance determining circuit works to determine the impedance of the sensor element based on a fraction of the voltage applied by said ac applying circuit to the sensor element which is given by a ratio of sum of resistance values of the resistor device and the capacitor device to a total of the resistance value and the impedance of the sensor element.

4. A sensor impedance measuring apparatus as set forth in claim 2, wherein the capacitor device is smaller in capacity than the sensor element.

5. A sensor impedance measuring apparatus as set forth in claim 4, wherein the capacitor device has a static capacity of 0.1 to 1 μF.

6. A sensor impedance measuring apparatus as set forth in claim 1, wherein said impedance determining circuit includes a peak hold circuit and receives the voltage, as sampled by said voltage sampling circuit, through the peak hold circuit.

7. A sensor impedance measuring apparatus as set forth in claim 2, wherein said impedance determining circuit determines the impedance of the sensor element based on the voltage, as sampled by said voltage sampling circuit, and a sum of resistance values of the resistor device and the capacitor device.

8. A sensor impedance measuring apparatus as set forth in claim 2, wherein said impedance determining circuit determines the impedance of the sensor element based on the voltage, as sampled by said voltage sampling circuit, and a resistance value of the resistor device.

9. A sensor impedance measuring apparatus as set forth in claim 7, wherein said ac applying circuit includes a power supply and two transistors joined in series between the power supply and ground, said ac applying circuit working to turn on the transistors alternately to produce the one of the alternating voltage and the alternating current, and wherein said impedance determining circuit determines the impedance of the sensor element also using an on-resistance of one of the transistors.

10. A sensor impedance measuring apparatus as set forth in claim 1, wherein said voltage sampling circuit samples a value of the voltage developed between the sensor element and said ac applying circuit when, after sweeping the one of the alternating voltage and the alternating current to one of a positive and a negative side, said ac applying circuit sweeps the one to the other of the positive and negative sides, and wherein said impedance determining circuit determines the impedance of the sensor element as a function of the value, as sampled by said voltage sampling circuit.

11. A sensor impedance measuring apparatus as set forth in claim 1, wherein said ac applying circuit produces the one of the alternating voltage and the alternating current at a frequency selected to be insensitive to a resistance of the current path.

12. A sensor impedance measuring apparatus as set forth in claim 1, wherein said ac applying circuit produces the one of the alternating voltage and the alternating current at a frequency selected to be greater than a change in concentration of the oxygen in the gas.

13. A sensor impedance measuring apparatus comprising:
a circuit line extending through a gas sensor equipped with a sensor element which includes a solid electrolyte body and a pair of electrodes affixed to opposed surfaces of the solid electrolyte body, the sensor element working to produce an electromotive force as a function of concentration of oxygen contained in a gas;
an ac applying circuit disposed in a current path that is a portion of said circuit line and leads to one of the electrodes of the sensor element, said ac applying circuit working to applying one of an alternating voltage and an alternating current to the sensor element;
a voltage sampling circuit working to sample a voltage developed between the sensor element and said ac applying circuit; and
an impedance determining circuit working to determine an impedance of the sensor element as a function of a value of the voltage sampled by said voltage sampling circuit while the one of the alternating voltage and the alternating current is being applied by said ac applying circuit to the sensor element.

14. A sensor impedance measuring apparatus as set forth in claim 13, further comprising a storage device installed in said ac applying circuit, said storage device working to block a flow of direct current and store charges therein and including a resistor device and a capacitor device which are connected in series, and wherein said impedance determining circuit determines the impedance of the sensor element based on the voltage, as sampled by said voltage sampling circuit, and a resistance value of the resistor device.

15. A sensor impedance measuring apparatus as set forth in claim 14, wherein said ac applying circuit includes a power supply and two transistors joined in series between the power supply and ground, said ac applying circuit working to turn on the transistors alternately to produce the one of the alternating voltage and the alternating current, and wherein said impedance determining circuit determines the impedance of the sensor element also using an on-resistance of one of the transistors.

16. A sensor impedance measuring apparatus as set forth in claim 13, wherein said voltage sampling circuit samples a value of the voltage developed between the sensor element and said ac applying circuit when, after sweeping the one of the alternating voltage and the alternating current to one of a positive and a negative side, said ac applying circuit sweeps the one to the other of the positive and negative sides, and wherein said impedance determining circuit determines the impedance of the sensor element as a function of the value, as sampled by said voltage sampling circuit.

17. A sensor impedance measuring apparatus as set forth in claim 13, wherein said ac applying circuit produces the one of the alternating voltage and the alternating current at a frequency selected to be insensitive to a resistance of the current path.

18. A sensor impedance measuring apparatus as set forth in claim 13, wherein said ac applying circuit produces the one of the alternating voltage and the alternating current at a frequency selected to be greater than a change in concentration of the oxygen in the gas.

19. A gas concentration measuring apparatus comprising:
a circuit line extending through a gas sensor equipped with a sensor element which includes a solid electrolyte body and a pair of electrodes affixed to opposed surfaces of the solid electrolyte body;
an ac applying circuit disposed in a current path that is a portion of said circuit line and leads to one of the electrodes of the sensor element, said ac applying circuit working to applying one of an alternating voltage and an alternating current to the sensor element;
a voltage sampling circuit working to sample a voltage developed between the sensor element and said ac applying circuit;
an impedance determining circuit working to determine an impedance of the sensor element as a function of a value of the voltage sampled by said voltage sampling circuit while the one of the alternating voltage and the alternating current is being applied by said ac applying circuit to the sensor element;
a voltage applying circuit disposed in said circuit line, said voltage applying circuit working to apply a voltage to the sensor element;
a current measuring circuit disposed in said circuit line, said current sampling circuit working to measure a current flowing therethruogh which arises from application of the voltage to the sensor element by said voltage applying circuit; and
a controller working to determine a concentration of oxygen in a gas using the current, as measured by said current measuring circuit, said controller working to block the application of the voltage to the sensor element when said ac applying circuit is required to apply the one of the alternating voltage and the alternating current to the sensor element, said controller also working to control the gas sensor using the impedance, as determined by said impedance determining circuit.

20. A gas concentration measuring apparatus as set forth in claim 19, further comprising a switch disposed between said voltage applying circuit and the sensor element, and wherein said controller opens said switch to block the application of the voltage to the sensor element.

21. A gas concentration measuring apparatus as set forth in claim 19, further comprising a storage device installed in said ac applying circuit, said storage device working to block a flow of direct current and store charges therein and including a resistor device and a capacitor device which are connected in series, and wherein said impedance determining circuit determines the impedance of the sensor element based on the voltage, as sampled by said voltage sampling circuit, and a resistance value of the resistor device.

22. A gas concentration measuring apparatus as set forth in claim 21, wherein said ac applying circuit includes a power supply and two transistors joined in series between the power supply and ground, said ac applying circuit working to turn on the transistors alternately to produce the one of the alternating voltage and the alternating current, and wherein said impedance determining circuit determines the impedance of the sensor element also using an on-resistance of one of the transistors.

23. A gas concentration measuring apparatus as set forth in claim 19, wherein said voltage sampling circuit samples a value of the voltage developed between the sensor element and said ac applying circuit when, after sweeping the one of the alternating voltage and the alternating current to one of a positive and a negative side, said ac applying circuit sweeps the one to the other of the positive and negative sides, and wherein said impedance determining circuit determines the impedance of the sensor element as a function of the value, as sampled by said voltage sampling circuit.

24. A gas concentration measuring apparatus as set forth in claim 19, wherein said ac applying circuit produces the one of the alternating voltage and the alternating current at a frequency selected to be insensitive to a resistance of the current path.

25. A gas concentration measuring apparatus as set forth in claim 19, wherein said ac applying circuit produces the one of the alternating voltage and the alternating current at a frequency selected to be greater than a change in concentration of the oxygen in the gas.
